(19) United States
(12) Patent Application Publication
(10) Pub. No.: US 2026/0268869 A1
(43) Pub. Date: Sep. 10, 2026

(54) REAL-TIME UPDATEABLE FERROFLUID SPECULAR HOLOGRAPHIC DISPLAY

(71) Applicant: Lenovo Global Technology (United States) Inc., Morrisville, NC (US)

(72) Inventors: Grason Humphrey, Morrisville, NC (US); Eric Li, Morrisville, NC (US); Michael DeCesaris, Morrisville, NC (US); Milton Cobo, Morrisville, NC (US)

(21) Appl. No.: 19/069,542

(22) Filed: Mar. 4, 2025

(51) Int. Cl. G09G 3/34; G03H 1/02; G03H 1/26; G06F 3/01; G09G 3/00; H01F 1/44

(52) U.S. Cl. CPC G09G 3/3486; G03H 1/02; G03H 1/268; G06F 3/012; G09G 3/003; H01F 1/44; G03H 2001/026; G09G 2354/00

(57) ABSTRACT

In one aspect, a device includes a processor system and storage accessible to the processor system. The storage includes instructions executable by the processor system to dynamically and magnetically influence ferrofluid in a specular holographic display to render holographic three dimensional (3D) images using the ferrofluid. The display may therefore be controlled in real time using one or more ferrofluid-related components inside the display to adjust the appearance of an object represented by the 3D images. In some particular instances, the appearance of the object may be adjusted based on user interaction with the object, such as the user trying to look around the object or the user providing a command to rotate the object.

### FIELD

The disclosure below relates to technically inventive, non-routine solutions that are necessarily rooted in computer technology and that produce concrete technical improvements. In particular, the disclosure below relates to real-time updateable ferrofluid specular holographic displays.

### BACKGROUND

Stereoscopic displays can present interactable three-dimensional (3D) images to a viewer. But as recognized herein, these displays often leave something to be desired in terms of realistic appearance of the 3D images. There are currently no adequate solutions to the foregoing computer-related, technological problem.

### SUMMARY

Accordingly, in one aspect a device includes a processor system and storage accessible to the processor system. The storage includes instructions executable by the processor system to magnetically influence ferrofluid in a specular holographic display to render a first three dimensional (3D) image using the ferrofluid. The instructions are also executable to receive a command to present, on the specular holographic display, a second 3D image different from the first 3D image. Responsive to the command, the instructions are executable to magnetically influence the ferrofluid to render the second 3D image using the ferrofluid.

In some examples, the first and second 3D images may be rendered by establishing, using the ferrofluid, one or more ridges on the specular holographic display.

Also in various examples, the command may be a command to rotate an object represented by the first 3D image, and the second 3D image may be a rotated version of the first 3D image. Additionally or alternatively, the command may be generated based on detecting head movement of a viewer.

In one non-limiting example embodiment, the instructions may be executable to magnetically influence the ferrofluid by selectively activating different magnets in a grid array to direct at least some of the ferrofluid to desired locations on a display surface of the specular holographic display.

Also in one non-limiting example embodiment, the instructions may be executable to magnetically influence the ferrofluid by rotating a first arm about an axis of rotation for a magnetized portion of the first arm to direct at least some of the ferrofluid to desired locations on a display surface of the specular holographic display.

Still further, in one non-limiting embodiment the instructions may be executable to magnetically influence the ferrofluid by rotating a first arm about a first axis of rotation for a magnetized portion of a second arm to direct at least some of the ferrofluid to desired locations on a display surface of the specular holographic display. The second arm may be different from the first arm, and the second arm may be mechanically linked to the first arm via a coupling that establishes a second axis of rotation between the first and second arms.

In some example implementations, the ferrofluid may include magnetic particles suspended in a carrier fluid. The carrier fluid may include water and/or oil, though other liquids may also be used. If desired, the ferrofluid may be reflective, and the device itself may even include the specular holographic display.

In another aspect, a method includes magnetically influencing ferrofluid in a display to establish first ridges on the display to render a first three dimensional (3D) image. The method also includes identifying a trigger to present, on the display, a second 3D image different from the first 3D image. The method further includes, responsive to identifying the trigger, magnetically influencing the ferrofluid to establish second ridges on the display to render the second 3D image.

In some example instances, the display may be a specular holographic display.

Additionally, in some non-limiting example implementations the method may include establishing the first and second ridges using a grid of individually-activable electromagnets to move at least some of the ferrofluid.

Additionally or alternatively, the method may include establishing the first and second ridges by moving a magnetized portion of an arm about a first axis of rotation in the display to direct at least some of the ferrofluid to desired locations on the display. In some examples, a single arm may be used. However, in other examples, the method may include moving two arms coupled to each other via a second axis of rotation in the display to direct at least some of the ferrofluid to the desired locations on the display.

In still another aspect, a device includes at least one computer readable storage medium (CRSM) that is not a transitory signal. The at least one CRSM includes instructions executable by a processor system to magnetically influence ferrofluid in a specular holographic display to render a three dimensional (3D) image on the specular holographic display.

In some examples embodiments, the instructions may be executable to track a user's head movement in relation to the specular holographic display and to magnetically influence the ferrofluid in real time as the user's head moves to change the rendering of the 3D image based on the user's head movement.

Also in some example embodiments, the instructions may be executable to activate, to render a first 3D image on the specular holographic display, a first magnet in an electromagnet array but not a second magnet in the electromagnet array. Here the instructions may then be executable to identify a trigger to present a second 3D image on the specular holographic, where the second 3D image may be different from the first 3D image. Responsive to the trigger, the instructions may then be executable to activate, to render the second 3D image on the specular holographic display, the second magnet but not the first magnet.

Still further, in some example implementations the instructions may be executable to magnetically influence the ferrofluid by rotating a first arm about an axis of rotation for a magnetized component in the display to direct at least some of the ferrofluid to desired locations on a display surface of the specular holographic display.

### BRIEF DESCRIPTION OF THE DRAWINGS

The details of present principles, both as to their structure and operation, can best be understood in reference to the accompanying drawings, in which like reference numerals refer to like parts, and in which:

FIG. 1 is a block diagram of an example system consistent with present principles;

FIG. 2 is a perspective view of an example specular holographic display consistent with present principles;

FIG. 3 is a perspective view showing an example specular holographic display in relation to a light source that emits incident light toward the display consistent with present principles;

FIG. 4 is a schematic illustrating how a virtual holographic point may be created by a curved ridge in a reflective surface of a specular holographic display consistent with present principles;

FIG. 5 illustrates example logic in flow chart format that may be executed by a specular holographic display and/or connected device consistent with present principles;

FIG. 6 shows an exploded side view of a first example embodiment of ferrofluid-related components that may be used in a specular holographic display consistent with present principles, with the first example embodiment including individually-activatable electromagnets in a grid array to influence ferrofluid in the display to create ridges in the display's reflective surface for 3D holographic image rendering; and

FIGS. 7 and 8 show schematics of second and third example embodiments of ferrofluid-related components that may be used in a specular holographic display consistent with present principles, with the second and third example embodiments including moving arms with electromagnets to influence ferrofluid to create ridges in the display's reflective surface for 3D holographic image rendering.

### DETAILED DESCRIPTION

Among other things, the detailed description below describes real-time, updateable, ferrofluid specular holographic displays that may be used to present true 3D images. This allows for occlusion and “looking around” the 3D image in real life. The displays disclosed herein may therefore be configured via various ferrofluid-related means to present autostereoscopic holographic images that are updateable in real-time, allowing the viewer to perceive the true, encoded 3D image even when moving his or her head to “look around” the image. This in turn avoids a break in the holographic illusion that would otherwise be perceived by the viewer as the viewer moves relative to the display. A relatively large viewing angle may therefore be afforded by present principles for adequate perception of the 3D effect of the image being rendered.

Accordingly, an otherwise 2D reflective display surface may exhibit curved engravings or ridges to create a perceived 3D image, using the reflective display surface to reflect light to the viewer's eyes in a way that allows perception of a true 3D image. Because the curves reflect light to each of the viewer's eyes at slightly different angles, the viewer perceives the reflected light glints as “virtual points” in 3D, either above or below the actual display surface. The position of each virtual point can be set to any position in 3D space by controlling the radius and center position of the reflective curve. Many curves can therefore be used to create many 3D virtual points, which may all combine to form a desired 3D virtual image to be seen by a human viewer.

With the foregoing in mind, in one particular aspect, innovative autostereoscopic displays may be both holographic and updateable in real-time. This gives the advantages of both displaying a true 3D image with a wide viewing angle (rather than displaying one or more stereoscopic two dimensional (2D) images) and also enabling the ability to change the image being displayed. To implement this, aspects discussed below provide for the changing of the shape of the display itself instead of simply digitally updating one or more 2D image display screens like liquid crystal displays, light emitting diode displays, etc. Doing so allows the specular holographic image to be updated in real-time, dynamically changing the shape of the reflective display surface on the fly for high-fidelity 3D image rendering as discussed further below.

In terms of certain ferrofluid embodiments discussed below, these example embodiments may be used to change the shape of the display in a variety of ways. For example, in one non-limiting embodiment, a real-time specular holographic display system may include a reflective ferrofluid serving as at least part of a flexible and reflective display screen, an array of electromagnets for deforming the ferrofluid display to the desired shape to thus render a desired specular hologram, a computer system to determine what screen deformations are needed in the first place to form the desired specular hologram, and a light source mounted at an angle to the screen to generate specular light glints. However, it is to be further understood that ambient front lighting and/or other front lighting may also be used to help create the 3D appearance for the image.

When the display is to be changed, the flexible display surface can be smoothed either by electrical or mechanical techniques to reset the deformations, and the process may begin again.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C # or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

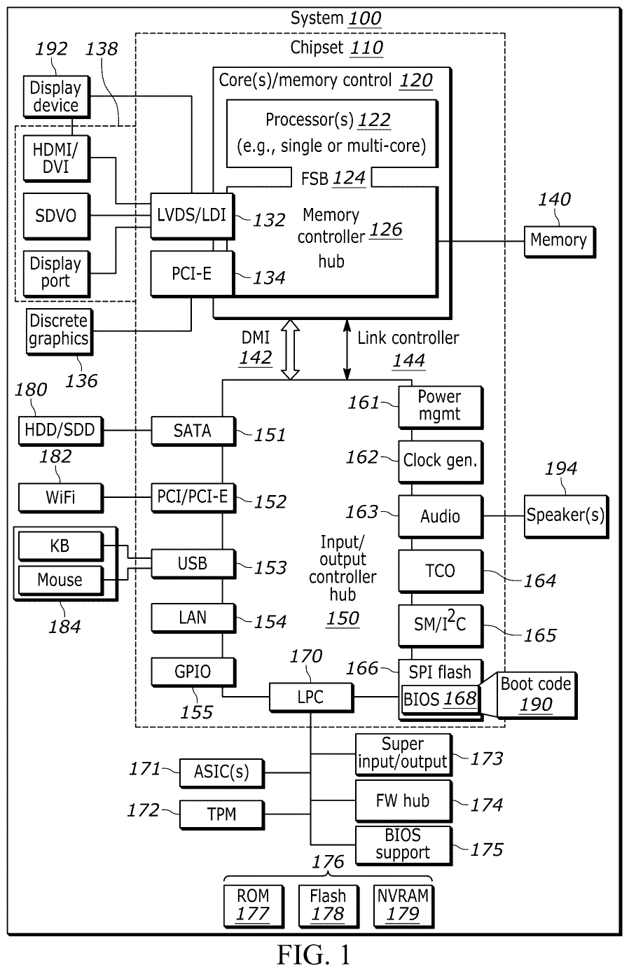

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

In addition, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

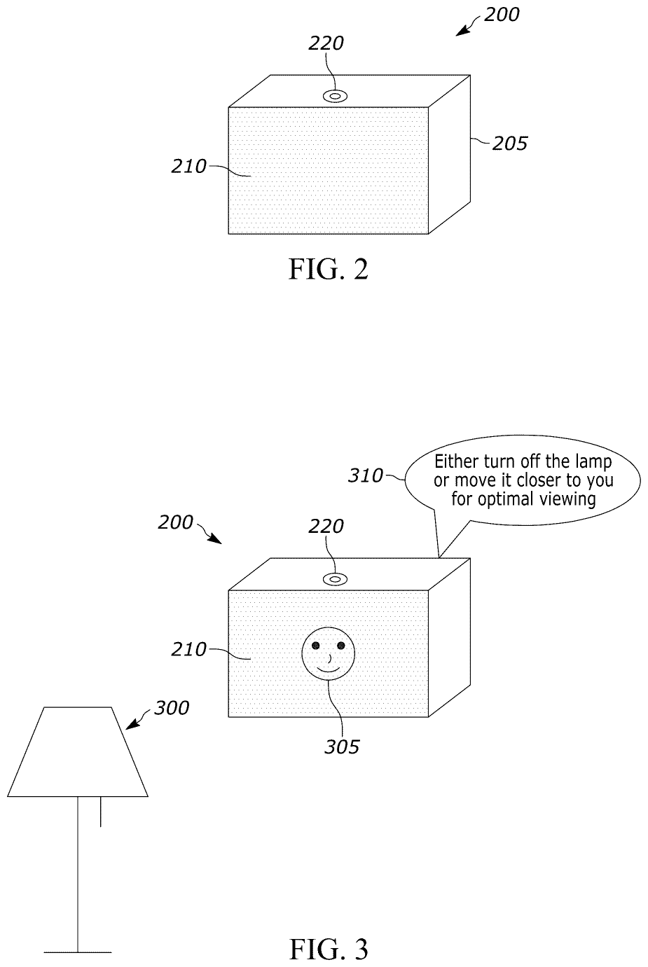

Turning to FIG. 2, this figure shows a perspective view of an example specular holographic display 200 consistent with present principles. The display 200 may include a housing 205 that houses some or all of the components of the system 100 described above. In the example shown, the housing 205 may be a rectangular prism or cuboid, though other shapes may also be used for the housing 205. The housing 205 may be made of a polymer, plastic, or other suitable material.

FIG. 2 also shows a flexible first (e.g., front) surface 210 of the display 200, with the shading for the first surface 210 demonstrating that the outer side of the first surface 210 may be made of/covered with a reflective material. As such, the outer side may be made of mylar, aluminum, and/or another suitable reflective material. Also note that in certain non-limiting embodiments, the outer sides of the other housing surfaces may be both rigid and made of/covered with non-reflective material to reduce the chance of 3D image distortions due to reflections of ambient or acute light off those surfaces. Further note that the reflective surface 210 itself (or at least its outer side) may be biased in a planar or convex in shape. The surface 210 may also be generally flat yet may still be dynamically imprintable with ridges as described in greater detail below to allow for the presentation of different 3D holographic images using the reflective outer side of the surface 210.

As also shown in FIG. 2, the display 200 may include a camera 220. The camera 220 may be controlled by a processor system inside the display 200 or a connected device (e.g., a smartphone wirelessly communicating with the display 200). The camera 220 may be used to identify user commands and track user head movements for changing a 3D presentation of the display accordingly.

For example, the user may provide a hand-based gesture command to rotate an object represented by the 3D image(s) being rendered on the display 200, with the display 200 then rotating the object according to the command in response (e.g., by presenting different 3D images showing the object from other angles as rotated versions of the prior 3D image). As another example, the user may physically move his or her head to different positions with respect to the display 200 to inspect the object from different angles, with the display then rotating the object according to the head movement in response to thus show another angle of the 3D object. Other triggers may also be detected using the camera 220 to then alter the appearance of the displayed object in response. Also note here that computer vision and gesture recognition may be used to identify visual commands via the input from the camera 220, with it being further noted that verbal commands as detected via a microphone on the display device 200 may also be used. Keyboard commands, cursor commands, and other types of commands may also be used to trigger a change in 3D images.

Turning to FIG. 3, this figure also shows a perspective view of the display 200. But here, the display 200 is being used to present a holographic 3D “smiley face” 305 via raised ridges in the surface 210.

As also shown in FIG. 3, light from a light source such as a lamp 300 might front-light the surface 210 from a particular angle. With present principles recognizing that the appearance of the holographic image 305 may be adversely affected by light from the acute light source 300 due to the acute light's angle of arrival, the display 200 may use its camera 220 and computer vision to identify the position of the light source 300 with respect to the display 200. Based on the display 200 detecting a suboptimal angle of light from the lamp 300 that causes the virtual points created by the ridges in the reflective surface 210 to be rendered off-center from their intended 3D virtual position according to the user's own viewing angle (also identified using the camera 220 and computer vision/eye tracking), the display may use one of its speakers to present an audible output represented by the speech bubble 310. As shown, the example audible output includes suggestions for optimizing the appearance of the holographic image(s) according to the user's viewing angle, such as “Either turn off the lamp or move the lamp closer to you for optimal viewing.”

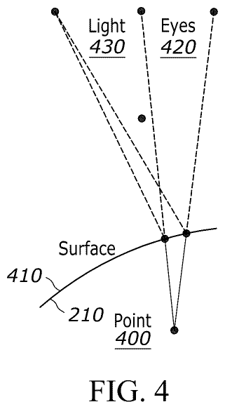

Now in reference to FIG. 4, this figure demonstrates how a virtual point 400 may be created by a curved ridge 410 in the reflective surface 210, thus using specular holography to create a perceived 3D image. The display 200 may therefore implement specular holography using curved ridges on an otherwise 2D surface to reflect light to the viewer's eyes 420 according to the user's viewing angle. Because the curves reflect light to each of the viewer's eyes at slightly different angles, the viewer perceives each of the reflected light glints as a “virtual point” 400 in 3D space, either in front of or behind the actual surface 210 itself. The display 200 can therefore set the position of each virtual point 400 to any desired position in 3D space by controlling the radius and center position of the reflective curve being made in the surface 210. The display 200 may use many different curves in the surface 210 to create many 3D virtual points 400, which may all combine to form a desired 3D virtual image to be seen by the viewer.

FIG. 4 also shows that a light source 430 like the lamp 300 might be directing acute light at the ridge 410 from another angle different from the user's viewing angle. The difference in angles between the light source 430 to the display surface 210 and the eyes 420 to the display surface 210 may be identified by the display 200 to then apply an offset for rendering the point 400 to appear at the intended position in 3D space. This may help with high-fidelity 3D holographic image rendering notwithstanding reflected light from the light source 430. This offset will be described in greater detail below.

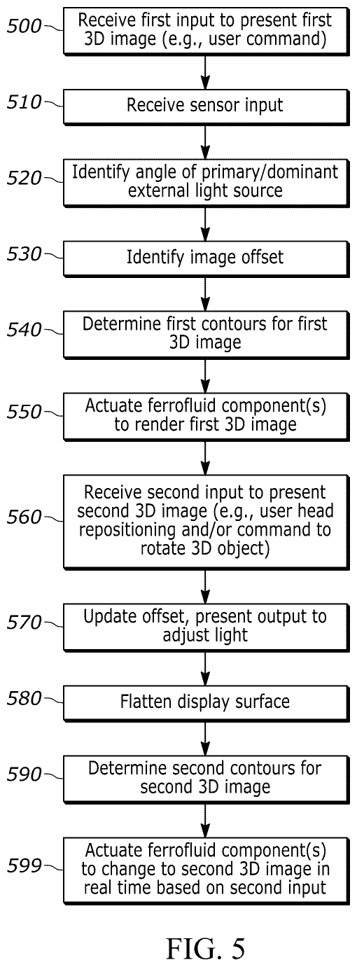

Referring now to FIG. 5, this figure shows example logic that may be executed by a device such as the display 200 and/or a connected device alone or in any appropriate combination consistent with present principles. The connected device might be a server and/or another client device like a smartphone that communicates with the display 200 over a Wi-Fi or other network. Also note that while the logic of FIG. 5 is shown in flow chart format, other suitable logic may also be used.

The logic may begin at block 500 where the display device may receive first input or identify another trigger to present a first 3D image on its specular holographic display. The first input may be a command received from a user, from another device, etc. The logic may then proceed to block 510 where the device may receive sensor input, such as input from the camera 220 as described above. However, further note that other types of optical sensors may also be used.

From block 510 the logic may then proceed to block 520. Here, the device may use the input from the optical sensor to identify both the angle of arrival of light from an acute light source emitting incident light toward the display, and the viewing angle of a viewer toward the display surface. In one particular example, computer vision may be executed at block 520 to make these identifications, through other image processing techniques may also be used.

The logic of FIG. 5 may then continue to block 530. At this step, the device may identify an image offset to apply to optimize rendering of the virtual points to appear at intended locations in 3D space according to the viewer's own viewing angle notwithstanding reflected light from the acute light source. Various machine learning techniques may be used to identify the offset, as well as one or more rules-based algorithms.

For instance, the offset may be determined as one degree of virtual object rotation (as represented in the 3D image) for every ten to twenty degrees of difference between the user's viewing angle and the acute light source angle as identified at block 520. This technique may help compensate for the slight image shift the user might otherwise perceive while also avoiding overcorrection that could also cause an image shift.

From block 530 the logic may then proceed to block 540. Here, the device may determine one or more first contours for a first 3D image that is to be rendered (according to any offset) via ridges in the display surface of the specular holographic display.

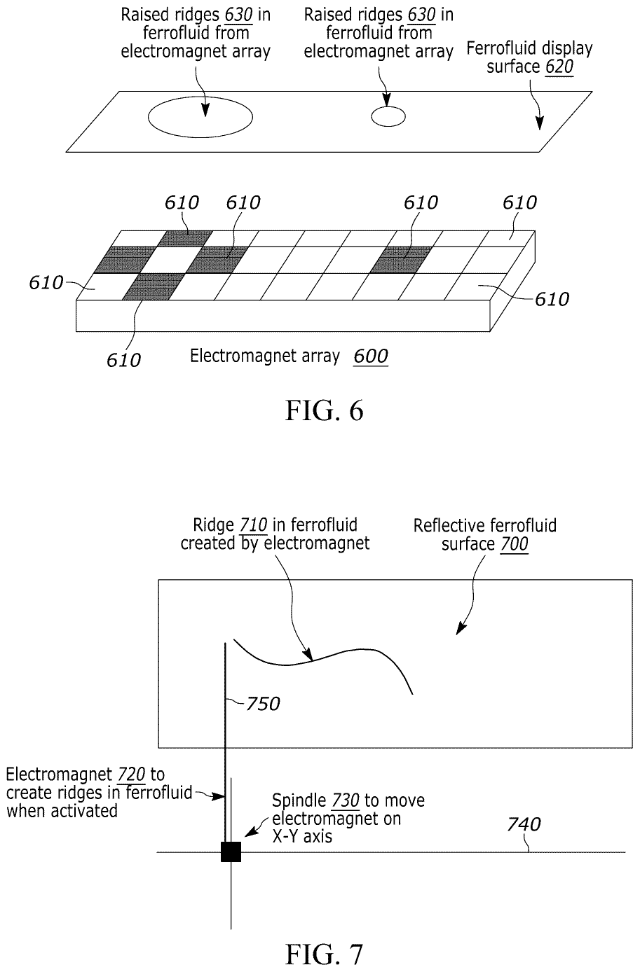

After block 540, the logic of FIG. 5 may proceed to block 550. At block 550 the device may control the specular holographic display to render the first 3D image. For example, at block 550 the device may actuate one or more ferrofluid-related components to render the first 3D image. Examples of such ferrofluid-related components will be discussed in greater detail below in reference to FIGS. 6-8. From block 550 the logic may then proceed to block 560.

At block 560 the device may receive second input (or identify another trigger) to present a second 3D image on the specular holographic display. The second 3D image may show the same object as the first 3D image but from a different angle, or may show a different object altogether. The object(s) might be an apple, the globe, a car part, a smiley face, etc.

In instances where the second 3D image shows the same object as the first 3D image but from a different viewing angle, the second input may be a user command to rotate the object itself that is being represented by the images. Additionally or alternatively, the second input may be generated based on head movement of the user (e.g., whether intended as a command or not), which in turn may be interpreted by the device as a trigger to rotate the object in the opposite direction as the head movement itself. Thus, note here that the device may access a stored 3D model of the object to use the vertices indicated in the 3D model to identify corresponding 3D points in space that are to be represented via the specular hologram (depending on the particular angle of view of the object that is to be rendered).

Responsive to receipt of the second input, the logic may then proceed to block 570. Here, the device may update the offset being applied based on any change in the user's viewing angle as compared to the incident light angle of arrival. In certain circumstances, at block 570 the device may also present an output to the viewer akin to the example audible output 310 described above (in addition to or in lieu of applying the updated offset), assisting the user in reducing the image shift themselves.

Also responsive to receipt of the second input, at block 580 the device may withdraw/deactivate the components used to make the ridges for the first 3D image so that the components and surface are no longer in physical contact (e.g., and the ferrofluid no longer being magnetically influenced by the electromagnet). The device may then flatten/smooth the display surface to remove any ridges/contours that remain. For example, straps inside the specular holographic display that are connected at each side of the display surface (according to its X-Y plane) may be reeled tight using a motor in the display. This may be done to apply tension to the display surface itself, making it taut and flat to erase the ridges. Then the straps may be released to provide slack for the next 3D image to be rendered on the flexible reflective display surface. Other electrical and mechanical means may also be used to remove the previous ridges and smoothen the display surface.

From block 580 the logic may proceed to block 590. Here, the device may determine one or more second contours for the second 3D image that is to be rendered in the display surface of the specular holographic display (possibly according to the updated offset). The logic may then proceed to block 599 to control the specular holographic display to render the second 3D image according to the user's real-time head movement or according to whatever user command is received.

Thus, at both of steps 550 and 590, the device may actuate the one or more ferrofluid-related components inside the specular holographic display's housing to magnetically influence at least some ferrofluid in the display to make the ridges in the display surface, rendering the relevant 3D image. Various example embodiments for different ferrofluid-related components that may be used consistent with present principles will now be described in reference to FIGS. 6-8. Note that the ferrofluid of these examples may include magnetic particles suspended in a carrier fluid such as water, oil, and/or another fluid.

Beginning first with the exploded side view of FIG. 6, this figure shows a first example of how ferrofluid-related components of a specular holographic display may be used to manipulate ferrofluid to establish ridges in the display's reflective surface, thus rendering 3D holographic images consistent with present principles. In this particular embodiment, the display may use an array 600 of individually-activable electromagnets 610 mounted underneath the ferrofluid display surface 620. Passing electrical current through one or more of the magnets 610 may therefore cause the ferrofluid encased within the surface 620 to take on desired shape(s) above the activated magnets 610 to create the desired holographic effect. Note that the electromagnets 610 may be arranged in the array 600 in M-by-N grid format, though other electromagnet arrangements may also be used. Also note that in one particular example, the array 600 may establish an X-Y plane that is parallel to another X-Y plane established by the display surface 620 when the components are assembled together on the specular holographic display itself.

Describing the (front) surface 620 in more detail, it may be flexible with its outer side being reflective, similar to the surface 210 described above. Additionally, the surface 620 may be generally shaped as a rectangular prism in non-limiting embodiments, with the aforementioned ferrofluid being encased within. However, other shapes may also be used for the surface 620. Also note that in certain examples, the ferrofluid inside the surface 620 may be reflective (e.g., where the surface's outer side itself is transparent).

In any case, the ferrofluid encased within the surface 620 may be controlled by the array 600 of electromagnets 610 to move the ferrofluid within the surface 620, forming desired ridges on the outer side of the surface 620 that extend distally away from the display itself to create a 3D effect via virtual points created by the surface 620 as discussed above. Accordingly, with the reflective ferrofluid surface 620 placed on top of the array 600 in an assembled specular holographic display, the display may control its circuitry to pass electric current individually through each of one or more magnets 610 (e.g., but not all of them concurrently), which in turn may cause the ferrofluid in the surface 620 to form raised ridges 630 above the activated magnets 610 according to the Z dimension.

It may be appreciated that in the example of FIG. 6, the ridges 630 establish circular 3D patterns, with currently-activated electromagnets 610 being shown with darker shading to demonstrate selective (current) activation of those respective magnets 610 at a given point in time. Corresponding regions of the surface 620 above the activated magnets 610 (according to the Z dimension) may thus exhibit the ridges 630 due to at least some of the ferrofluid in the surface 620 being magnetically influenced by (attracted to) the activated magnets 610. The activated magnets 610 may therefore direct at least some of the ferrofluid to accumulate at the desired locations of the surface 620. It may thus be appreciated that the raised ridges 630 formed by the higher concentration of ferrofluid at the relevant regions may create a specular holographic effect when a user views the outer side of the surface 620 as described herein.

Then when the activated electromagnets are turned off (e.g., the display stops passing current through each activated magnet individually using its circuitry), the ferrofluid that has concentrated to create the desired ridges 630 may disperse within the surface 620, making the outer surface flat again. Also note that the surface 620 may additionally or alternatively be flattened (and ferrofluid therefore dispersed) as described in reference to block 580 above.

With the foregoing in mind, according to one specific example implementation, a processor system within (or in communication with) a specular holographic display that includes the ferrofluid-related components described above may selectively activate, to render a first 3D image on the specular holographic display, one or more first magnets in the array 600 but not one or more second magnets in the array 600. The processor system may then identify a trigger to present a second 3D image on the specular holographic display that is different from the first 3D image. In response to the trigger, the processor system may then selectively activate, to render the second 3D image on the specular holographic display, one or more third magnets in the array 600 but not the first magnet(s). Thus, in some specific non-limiting instances, the processor system may deactivate the first magnet(s) responsive to the trigger before or concurrent with activating the third magnet(s). The third magnet(s) may be the same as, or different from, the second magnet(s).

Also note consistent with present principles that the Z dimension height of the ridges that are formed for the first and second 3D images may vary according to the amount of electric current applied individually to each of the magnets 610. Accordingly, the current to each magnet 610 may be selectively controlled and adjusted by the display, with the display applying progressively (e.g., incrementally) more current to create progressively (e.g., incrementally) higher ridges and progressively less current to create progressively lower ridges. In this way, the display may create the intended specular holographic effect with different virtual points appearing at different depths in real space from the perspective of the viewer based on the amount of current applied at each individual magnet 610, creating the holograms of the first and second 3D images.

Continuing the detailed description in reference to the schematic of FIG. 7, this figure shows another example embodiment for implementing specular holography using ferrofluid in a specular holographic display. In particular, this figure demonstrates that ridges 710 may be established in a flexible reflective display surface 700 (with ferrofluid encased within) by pushing respective distal end portions 750 of respective electromagnets 720 into a first (inner) side of the reflective surface 700 to magnetically influence (attract) the ferrofluid to form the ridges 710 in the second (outer) side of the reflective surface 700. Each electromagnet 720 may be mounted to a spindle 730 that itself is mounted to a board 740 inside the specular holographic display. In non-limiting examples, the board 740 may establish an X-Y plane that is parallel to an X-Y plane established by the surface 700.

Also note that only one electromagnet 720 and spindle 730 combination are shown in FIG. 7 for simplicity, but that the board 740 may include many electromagnet/spindle combinations to render a desired holographic image. Also note per the example shown that the electromagnet 720 may be established by, or integrated with, a stylus or other elongated arm (e.g., pin) that can be raised toward the surface 700 to press into the first (inner) side of the surface 700 to create the ridges 710 that extend away from the other side.

Accordingly, the display may acuate the spindle 730 via a motor inside the display to rotate the electromagnet/arm 720 about an axis of rotation established by the spindle 730 for the magnetized distal end portion 750 of the electromagnet 720 to move against the inner side of the display surface 700. This, in turn, influences at least some of the ferrofluid in the surface 700 to direct that ferrofluid to desired locations on the display surface 700. Also note that, if desired, the display may pass varying amounts of current through the electromagnet 720 at different times as the magnet 720 moves across the inner side of the surface 700, creating different ridges of different desired heights through the magnet's attraction of different amounts of ferrofluid to the relevant surface regions. It may thus be appreciated that the spindle 730 may move the electromagnet 720 on an X-Y axis to create the ridge(s) 710 on the surface 700 according to the X-Y plane established by the surface 700 so that the ridge(s) 710 extend distally away from the surface 700 at different desired heights.

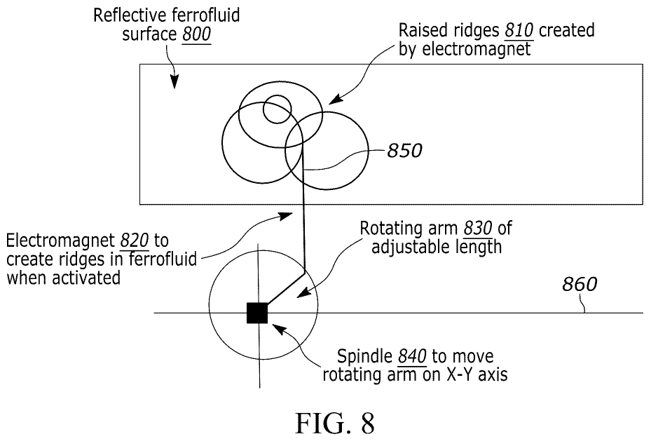

Now in reference to FIG. 8, this figure shows yet another example embodiment for implementing specular holography via ferrofluid-related components inside a specular holographic display. This figure also demonstrates that raised ridges 810 may be established in the flexible reflective display surface 800, pushing respective distal end portions 850 of respective electromagnets/arms 820 into a first (inner) side of the reflective surface 800 to form the ridges 810 extending away from a second (outer) side of the reflective surface 800. It is to be understood that the embodiment of FIG. 8 may be similar to the embodiment of FIG. 7, with the following differences being enumerated.

Specifically, per FIG. 8, each arm/spindle combination (only one being shown for simplicity) may include not only a first electromagnet/arm 820 that presses into the first side of the surface 800, but also a second arm 830 of adjustable length. The second arm 830 may be mechanically linked to the first electromagnet/arm 820 via a joint or other coupling. Accordingly, the second arm 830 may be coupled at one end to the first arm 820, and coupled at the opposite end to a spindle 840. Each spindle 840 may be mounted to a board 860 inside the specular holographic display, where the board 860 may establish an X-Y plane that is parallel to an X-Y plane established by the surface 800 that encases the ferrofluid. It may therefore be appreciated that the spindle 840 may move the rotating second arm 830 about the spindle's X-Y axis of rotation, which in turn rotates the electromagnet/first arm 820 about another axis of rotation established by the coupling between the first and second arms 820, 830 to then create the ridges 810 in the surface 800.

Additionally, since the arm 830 has an adjustable length, the display device may dynamically adjust the length of the second arm 830 using microelectromechanical (MEMS) linkage while rotating the second arm 830 about the first (spindle) axis of rotation. This, in turn, not only rotates the electromagnet/first arm 820 according to the second axis of rotation established by the coupling of the arms 820/830, but also alters the depth at which the magnetized distal end portion 850 extends into the display surface 800. The second arm 830 may thus be rotated about the first axis of rotation for the distal end portion 850 of the first arm 820 to move against the inner side of the reflective display surface 800 at varying depths with the electromagnet/first arm 820 activated, magnetically influencing at least some of the ferrofluid to direct that ferrofluid to desired locations on the display surface 800 (locations above the distal end portion 850). And again note that the electromagnet 820 may be activated by passing varying amounts of current through it at different times as it moves across inner side of the surface 800, helping to create different ridges of different heights as described above.

Accordingly, in adjusting the length of the intervening arm 830 between the spindle 840 and arm 820 to press the magnetized distal end portion 850 into the surface 800 at different depths, the desired ridges 810 may be created in the surface 800 not just according to the X-Y plane of the surface 800 similar to FIG. 7 (e.g., using varying levels of current at the electromagnet 820), but also based on the portion 850 extending more into the surface 800 in the Z dimension to create ridges of even greater height than through electromagnet current control alone. This too may help create a desired hologram using ridges of different heights that extend distally away from the surface 800.

It may now be appreciated that present principles provide for an improved computer-based user interface. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
magnetically influence ferrofluid in a specular holographic display to render a first three dimensional (3D) image using the ferrofluid;
receive a command to present, on the specular holographic display, a second 3D image that is different from the first 3D image; and
responsive to the command, magnetically influence the ferrofluid to render the second 3D image using the ferrofluid.

2. The device of claim 1, wherein the first and second 3D images are rendered by establishing, using the ferrofluid, one or more ridges on the specular holographic display.

3. The device of claim 1, wherein the command is a command to rotate an object represented by the first 3D image, and wherein the second 3D image is a rotated version of the first 3D image.

4. The device of claim 1, wherein the command is generated based on detecting head movement of a viewer.

5. The device of claim 1, wherein the instructions are executable to:
magnetically influence the ferrofluid by selectively activating different magnets in a grid array to direct at least some of the ferrofluid to desired locations on a display surface of the specular holographic display.

6. The device of claim 1, wherein the instructions are executable to:
magnetically influence the ferrofluid by rotating a first arm about an axis of rotation for a magnetized portion of the first arm to direct at least some of the ferrofluid to desired locations on a display surface of the specular holographic display.

7. The device of claim 1, wherein the instructions are executable to:
magnetically influence the ferrofluid by rotating a first arm about a first axis of rotation for a magnetized portion of a second arm to direct at least some of the ferrofluid to desired locations on a display surface of the specular holographic display, the second arm being different from the first arm, the second arm being mechanically linked to the first arm via a coupling that establishes a second axis of rotation between the first and second arms.

8. The device of claim 1, wherein the ferrofluid comprises magnetic particles suspended in a carrier fluid.

9. The device of claim 8, wherein the carrier fluid comprises one or more of: water, oil.

10. The device of claim 1, wherein the ferrofluid is reflective.

11. The device of claim 10, comprising the specular holographic display.

12. A method, comprising:
magnetically influencing ferrofluid in a display to establish first ridges on the display to render a first three dimensional (3D) image;
identifying a trigger to present, on the display, a second 3D image that is different from the first 3D image; and
responsive to identifying the trigger, magnetically influencing the ferrofluid to establish second ridges on the display to render the second 3D image.

13. The method of claim 12, wherein the display is a specular holographic display.

14. The method of claim 12, comprising:
establishing the first and second ridges using a grid of individually-activable electromagnets to move at least some of the ferrofluid.

15. The method of claim 12, comprising:
establishing the first and second ridges by moving a magnetized portion of an arm about a first axis of rotation in the display to direct at least some of the ferrofluid to desired locations on the display.

16. The method of claim 15, comprising:
moving two arms coupled to each other via a second axis of rotation in the display to direct at least some of the ferrofluid to the desired locations on the display.

17. A device, comprising:
at least one computer readable storage medium (CRSM) that is not a transitory signal, the at least one CRSM comprising instructions executable by a processor system to:
magnetically influence ferrofluid in a specular holographic display to render a three dimensional (3D) image on the specular holographic display.

18. The device of claim 17, wherein the instructions are executable to:
track a user's head movement in relation to the specular holographic display; and
magnetically influence the ferrofluid in real time as the user's head moves to change the rendering of the 3D image based on the user's head movement.

19. The device of claim 17, wherein the instructions are executable to:
activate, to render a first 3D image on the specular holographic display, a first magnet in an electromagnet array but not a second magnet in the electromagnet array;
identify a trigger to present a second 3D image on the specular holographic, the second 3D image being different from the first 3D image; and
responsive to the trigger, activate, to render the second 3D image on the specular holographic display, the second magnet but not the first magnet.

20. The device of claim 17, wherein the instructions are executable to:
magnetically influence the ferrofluid by rotating a first arm about an axis of rotation for a magnetized component in the display to direct at least some of the ferrofluid to desired locations on a display surface of the specular holographic display.
